(19) United States
(12) Patent Application Publication
(10) Pub. No.: US 2013/0259617 A1
(43) Pub. Date: Oct. 3, 2013

(54) OVERHEAD CARTRIDGE PLACEMENT SYSTEM

(71) Applicant: Ming WANG, Hsinchu County (TW)

(72) Inventor: Ming WANG, Hsinchu County (TW)

(21) Appl. No.: 13/431,420

(22) Filed: Mar. 27, 2012

(51) Int. Cl. B65G 1/06

(52) U.S. Cl. 414/561

(57) ABSTRACT

An overhead cartridge placement system is hung from a ceiling to suspend in an area over a machine and can be optionally configured for connecting to an overhead transport (OHT) system, and includes a platform, a suspension device, and a cartridge transport device. The cartridge transport device can grip a cartridge from the platform, and transports the gripped cartridge to a predetermined position for the OHT system to further transport the cartridge to the machine, or directly transports the gripped cartridge to the machine. The cartridge transport device can also grip the cartridge from the predetermined position or directly from the machine, and transport the gripped cartridge to the platform for storage. With these arrangements, the space over the machine can be effectively utilized for placement of more cartridges to avoid occupying floor areas, and the infrastructure cost for a plant can be reduced.

### FIELD OF THE INVENTION

The present invention relates to an overhead cartridge placement system, and more particularly to an overhead placement system for cartridges holding semiconductor elements.

### BACKGROUND OF THE INVENTION

With the development in the semiconductor technology, plants in many different industrial fields, such as display panel plants, semiconductor plants, solar energy equipment plants and the like, have production lines involving in the handling or manufacturing of related semiconductor elements. These semiconductor elements, such as semiconductor wafers, masks and so on, are frequently transported from one position to another position during the manufacturing processes.

The semiconductor elements to be transported or stored are first placed in specially structured cartridges to avoid being contaminated by impurities. When the semiconductor elements are not in use, the cartridges with the semiconductor elements held therein are placed on specific storage shelves until they are needed next time.

A storage zone is required for placing and retrieving the large quantity of cartridges at any time. Conventionally, an overhead shuttle (OHS) type stocker system is adopted to store the cartridges, and an overhead transport (OHT) system for transporting the cartridges is used with the OHS stocker system to form an automated transporting facility in the plant. In view of the high cost for building the conventional OHS stocker system, small-scale movable storage shelves are usually used along with the conventional stocker system for placing and storing the cartridges. However, the large number of small-scale storage shelves has the disadvantages of tending to cause confusion in the smooth movement of goods and persons in the plant, occupying a large area in the machine zone, and failing to connect to the OHT system for transporting the cartridges efficiently.

### SUMMARY OF THE INVENTION

A primary object of the present invention is to provide an overhead cartridge placement system that can provide more placement areas for cartridges without occupying floor space for machines to thereby reduce the plant equipment cost.

Another object of the present invention is to provide an overhead cartridge placement system that can be linked to an overhead transport (OHT) system.

To achieve the above and other objects, the overhead cartridge placement system according to an embodiment of the present invention is hung from a ceiling to suspend in an area over a machine and connected to an OHT system. In this embodiment, the overhead cartridge placement system includes a platform, a suspension device, and a cartridge transport device. The platform provides placement areas for a plurality of cartridges, in which semiconductor elements are held; and includes a predetermined position correspondingly located below a path of the OHT system. The suspension device connects the platform to the ceiling, so that the platform is suspended in the area over the machine. The cartridge transport device can grip a desired cartridge from the platform and transport the gripped cartridge to the predetermined position, from where the cartridge is transported to the machine by the OHT system. The cartridge transport device can also grip the cartridge transported to the predetermined position by the OHT system and transport the gripped cartridge to the platform for storage.

In a first embodiment of the present invention, the cartridge transport device includes a cartridge gripping/releasing unit for gripping or releasing the cartridge; a first-axis transport member located in a space above the platform and connected to the cartridge gripping/releasing unit for the same to move along a first direction; a second-axis transport member located in the space above the platform and connected to the first-axis transport member for the cartridge gripping/releasing unit and the first-axis transport member to move along a second direction; a third-axis transport member located in the space above the platform and connected to the second-axis transport member for the cartridge gripping/releasing unit, the first-axis transport member and the second-axis transport member to move along a third direction; and a conveyor belt arranged on the platform and having a load/unload position and the predetermined position for conveying the cartridge on the load/unload position to the aforesaid predetermined position, and also for conveying the cartridge on the predetermined position to the load/unload position.

In a second embodiment of the present invention, the cartridge transport device includes two parallelly spaced rails arranged on the platform; a movable carrier connected to between the two parallelly spaced rails, and guided by the two parallel rails to move along a uniaxial path on the platform, and the predetermined position being included in the uniaxial path, and the cartridges being placed on the platform at two lateral sides of the uniaxial path; and a cartridge gripping/releasing unit for extending into the placement areas to grip or release the cartridge therefrom or thereto, and for gripping or releasing the cartridge from or to the predetermined position.

To achieve the above and other objects, the overhead cartridge placement system according to another embodiment of the present invention is hung from a ceiling to suspend in an area over a machine and configured for directly transporting a cartridge from the placement system to the machine without using an OHT system. In this embodiment, the overhead cartridge placement system includes a platform providing placement areas for a plurality of cartridges, in which semiconductor elements are held; a suspension device connecting the platform to the ceiling, so that the platform is suspended in the area over the machine; and a cartridge transport device for gripping a desired cartridge from the platform and transporting the gripped cartridge to a working position on the machine, or gripping a cartridge from the working position on the machine and transporting the gripped cartridge back to the platform for storage.

With the above arrangements, the overhead cartridge placement system of the present invention provides a low-cost solution for fully utilizing the space in a plant and is therefore helpful in smooth flow and upgraded efficiency of operation on the machine.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic elevation view showing the arrangement of an overhead cartridge placement system according to an embodiment of the present invention;

FIG. 2 is a schematic perspective view showing a cartridge transport device for the overhead cartridge placement system according to a first embodiment of the present invention; and

FIG. 3 is a schematic perspective view showing a cartridge transport device for the overhead cartridge placement system according to a second embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

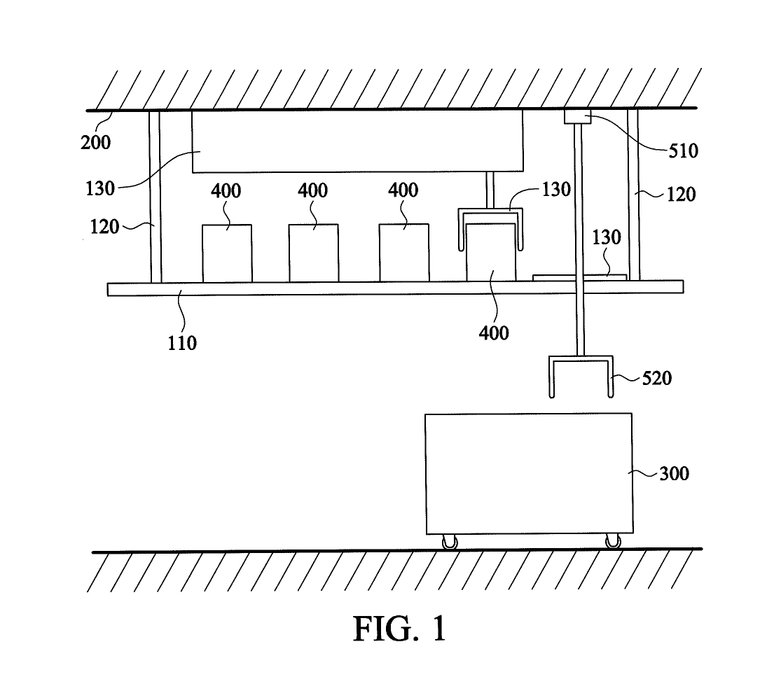

Please refer to FIG. 1 that is a schematic elevation view showing the arrangement of an overhead cartridge placement system according to an embodiment of the present invention. As shown, the overhead cartridge placement system is suspended in an area over a machine 300, and is, for example, hung from a ceiling 200. That is, the present invention is implemented by making use of the space in a plant over a machine that has a low height. In practical implementation, the space for installing the overhead cartridge placement system of the present invention can be selected according to an actual layout in the plant. The present invention can be connected to and used with an overhead transporter (OHT) system, or be used alone to directly transport cartridges to and from the machine. The embodiment of the present invention shown in FIG. 1 is the overhead cartridge placement system connected to and used with the OHT system. As to the overhead cartridge placement system of the present invention without using the OHT system, it includes a cartridge transport device for directly transporting cartridges to and from a working position (not shown) on the machine. One of ordinary skill in the art may refer to FIG. 1 and make necessary modifications thereto based on the above description to achieve the overhead cartridge placement system of the present invention for directly transporting cartridges to and from the machine.

The area over the machine referred herein includes the area immediately above the machine and the area over and surrounding the machine. Generally, there is an OHT system passing over the machine 300. Thus, to obtain increased transport efficiency, the overhead cartridge placement system of the present invention is also installed in the area over the machine 300 to connect to the OHT system. However, the overhead cartridge placement system of the present invention installed in the area over the machine 300 may also be configured for directly and more quickly transporting cartridges 400 to and from a working position (not shown) on the machine 300 without using the OHT system.

As can be seen in FIG. 1, the overhead cartridge placement system of the present invention connected to an OHT system includes a platform 110, a suspension device 120, and a cartridge transport device 130. The suspension device 120 connects the platform 110 to the ceiling 200, such that the platform 110 is suspended in the area above the machine 300. The platform 110 provides placement areas for a plurality of cartridges 400, in which semiconductor elements are held. The OHT system includes a track 510 and a gripper 520. On the platform 110, there is a predetermined position correspondingly located below the track 510. The cartridge transport device 130 grips a cartridge 400 from the platform 110, transports the gripped cartridge 400, and places the cartridge 400 on the predetermined position, over which the track 510 passes. From the predetermined position, the cartridge 400 is further transported to the machine 300 by the gripper 520 of the OHT system. The cartridge transport device 130 can also grip a cartridge 400 placed on the predetermined position by the gripper 520 and transports the cartridge 400 to the placement areas on the platform 110 for storage.

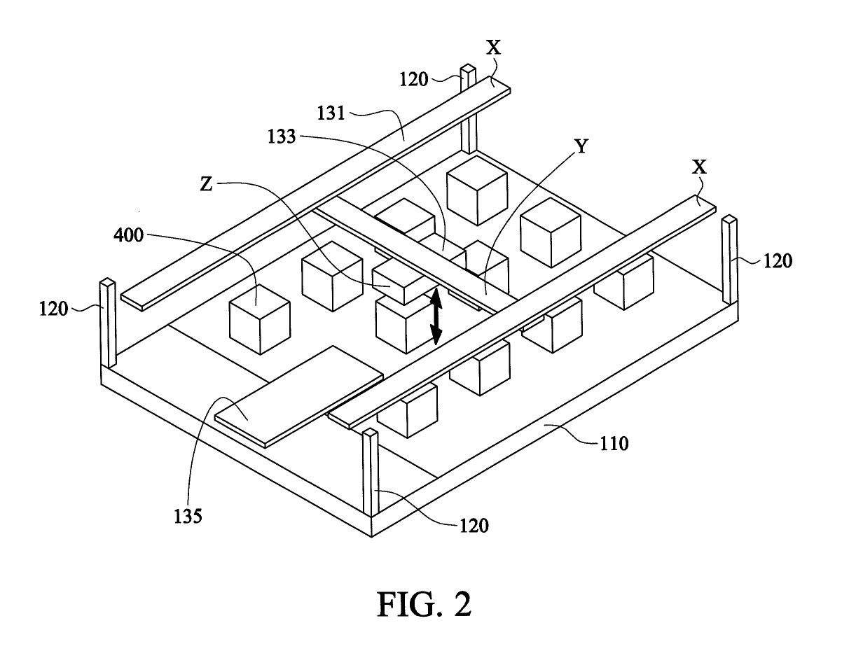

Please refer to FIG. 2 that is a schematic perspective view showing the cartridge transport device 130 for the overhead cartridge placement system according to a first embodiment of the present invention. In the first embodiment, the cartridge transport device 130 includes a cartridge gripping/releasing unit 133; a three-axis transport unit 131, which includes a first-axis transport member Z, a second-axis transport member Y and a third-axis transport member X; and a conveyor belt 135. The cartridge gripping/releasing unit 133 is used to grip or release a cartridge 400.

The first-axis transport member Z is located in a space above the platform 110 and is connected to the cartridge gripping/releasing unit 133 for the same to move along a first direction, such as the z-axis direction. The second-axis transport member Y is located in the space above the platform 110 and is connected to the first-axis transport member Z for the cartridge gripping/releasing unit 133 and the first-axis transport member Z to move along a second direction, such as the y-axis direction. The third-axis transport member X is located in the space above the platform 110 and connected to the second-axis transport member Y for the cartridge gripping/releasing unit 133, the first-axis transport member Z, and the second-axis transport member Y to move along a third direction, such as the x-axis direction. The conveyor belt 135 is arranged on the platform 110 and provides a load/unload position and the aforesaid predetermined position for conveying a cartridge 400 on the load/unload position to the predetermined position, or conveying a cartridge 400 on the predetermined position to the load/unload position. Therefore, based on preset control procedures, the cartridge transport device 130 shown in FIG. 1 can be operated to substitute for part of the OHS stocker system.

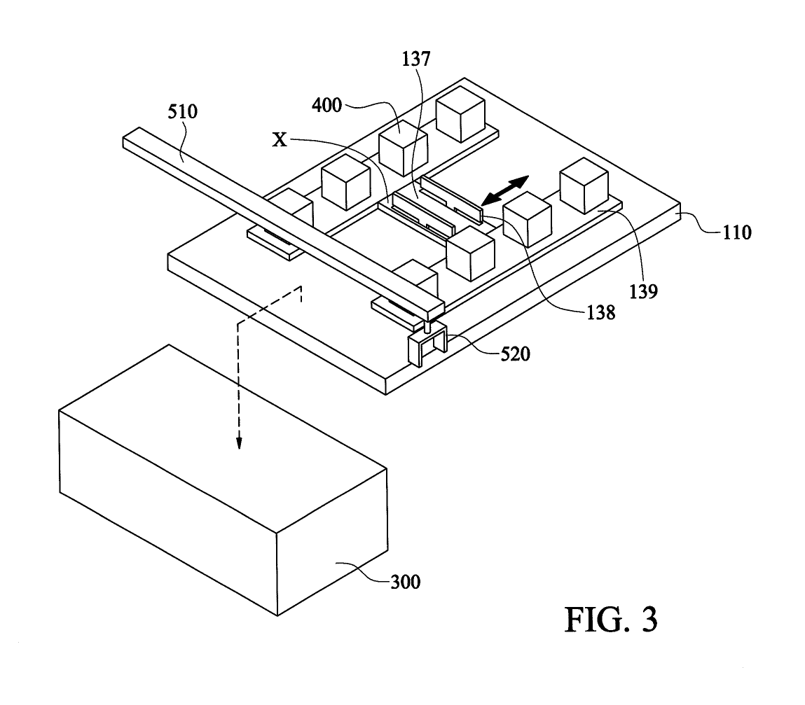

Please refer to FIG. 3 that is a schematic perspective view showing a cartridge transport device 130 for the overhead cartridge placement system according to a second embodiment of the present invention. As shown, in the second embodiment, the cartridge transport device 130 includes two parallelly spaced rails 139, a movable carrier 137, and a cartridge gripping/releasing unit 138. The two parallel rails 139 are arranged on the platform 110. The movable carrier 137 is connected to between the two parallel rails 139 and guided by the rails 130 to move along a uniaxial path on the platform 110. The aforesaid predetermined position is included in the uniaxial path, and the cartridges 400 are placed on the platform 110 at two lateral sides of the uniaxial path. The cartridge gripping/releasing unit 138 can be, for example, a retractable robotic arm for extending into the placement areas or the predetermined position to grip or release a cartridge 400 thereat.

In the embodiments shown in FIGS. 1 to 3, the overhead cartridge placement system of the present invention is connected to an OHT system. That is, the OHT system transports the cartridge on the predetermined position to a working position on the machine, so that an automated apparatus on the machine can access the cartridge for use; and after completion of the use of the cartridge on the machine, the OHT system transports the cartridge back to the predetermined position, so that cartridge transport device of the overhead cartridge placement system of the present invention can further transport the cartridge back to its storage position on the platform.

According to another embodiment of the present invention, the overhead cartridge placement system is configured for directly transporting a cartridge to and from the working position on the machine. While the overhead cartridge placement system in this embodiment is generally similar to that connected to an OHT system as illustrated in FIGS. 1 to 3 and includes a platform, a suspension device, and a cartridge transport device, it does not need to arrange the aforesaid predetermined position. That is, in the overhead cartridge placement system according to another embodiment of the present invention, the platform is only used to provide placement areas for cartridges having semiconductor elements held therein, the cartridge transport device works only to grip and transport the cartridges from the platform to the working position on the machine for use, as well as to grip and transport the cartridges from the working position on the machine back to the platform for storage.

In the overhead cartridge placement system that directly transports the cartridges 400 to the machine, the cartridge transport device thereof similarly includes a cartridge gripping/releasing unit, a first-axis transport member, a second-axis transport member and a third-axis transport member, but not the conveyor belt. The cartridge gripping/releasing unit is directly extended into the machine to release the cartridge to the working position on the machine, or directly grip and transport the cartridge from the working position back to the platform.

The embodiments shown in the drawings are only illustrative. It is understood one of ordinary skill in the art can easily form loading and unloading ports on the platform 110 based on the above disclosed technical features, so as to facilitate smooth transport of the gripped cartridge to and from the platform by the OHT system, in the case of the overhead cartridge placement system connected to an OHT system, or by the cartridge transport device, in the case of the overhead cartridge placement system for directly transporting the cartridges 400 to and from the working position on the machine.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An overhead cartridge placement system being hung from a ceiling to suspend in an area over a machine and connected to an overhead transport (OHT) system, comprising:
a platform for providing placement areas for a plurality of cartridges, in which semiconductor elements are held; and the platform including a predetermined position correspondingly located below a path of the OHT system;
a suspension device connecting the platform to the ceiling, so that the platform is suspended in the area over the machine; and
a cartridge transport device for gripping the cartridge from the platform and transporting the gripped cartridge to the predetermined position, from where the cartridge is further transported to the machine by the OHT system; and the cartridge transport device also gripping the cartridge transported to the predetermined position by the OHT system and transporting the gripped cartridge to the platform for storage.

2. The overhead cartridge placement system as claimed in claim 1, wherein the cartridge transport device includes:
a cartridge gripping/releasing unit for gripping or releasing the cartridge;
a first-axis transport member located in a space above the platform and connected to the cartridge gripping/releasing unit for the same to move along a first direction;
a second-axis transport member located in the space above the platform and connected to the first-axis transport member for the cartridge gripping/releasing unit and the first-axis transport member to move along a second direction;
a third-axis transport member located in the space above the platform and connected to the second-axis transport member for the cartridge gripping/releasing unit, the first-axis transport member and the second-axis transport member to move along a third direction; and
a conveyor belt arranged on the platform and providing a load/unload position and the predetermined position for conveying a cartridge on the load/unload position to the predetermined position, and also for conveying a cartridge on the predetermined position to the load/unload position.

3. The overhead cartridge placement system as claimed in claim 1, wherein the cartridge transport device includes:
two parallelly spaced rails arranged on the platform;
a movable carrier connected to between the two parallel rails, and guided by the two parallel rails to move along a uniaxial path on the platform; the predetermined position being included in the uniaxial path; and the cartridges being placed on the platform at two lateral sides of the uniaxial path; and
a cartridge gripping/releasing unit for extending into the placement areas to grip or release the cartridge therefrom or thereto, and for gripping or releasing the cartridge from or to the predetermined position.

4. An overhead cartridge placement system being hung from a ceiling to suspend in an area over a machine, comprising:
a platform for providing placement areas for a plurality of cartridges, in which semiconductor elements are held;
a suspension device connecting the platform to the ceiling, so that the platform is suspended in the area over the machine; and
a cartridge transport device for gripping the cartridge from the platform and transporting the gripped cartridge to a working position on the machine; and the cartridge transport device also gripping the cartridge from the working position on the machine and transporting the gripped cartridge back to the platform for storage.

5. The overhead cartridge placement system as claimed in claim 4, wherein the cartridge transport device includes:
a cartridge gripping/releasing unit for gripping or releasing the cartridge;
a first-axis transport member located in a space above the platform and connected to the cartridge gripping/releasing unit for the same to move along a first direction;
a second-axis transport member located in the space above the platform and connected to the first-axis transport member for the cartridge gripping/releasing unit and the first-axis transport member to move along a second direction; and
a third-axis transport member located in the space above the platform and connected to the second-axis transport member for the cartridge gripping/releasing unit, the first-axis transport member and the second-axis transport member to move along a third direction.
